(19) United States
(12) Patent Application Publication
(10) Pub. No.: US 2012/0323822 A1
(43) Pub. Date: Dec. 20, 2012

(54) SYSTEM AND METHOD FOR ADAPTIVE ITEM PRICING

(75) Inventor: Kun Wei, Shanghai (CN)

(73) Assignee: EBAY INC., SAN JOSE, CA (US)

(21) Appl. No.: 13/518,857

(22) PCT Filed: Jan. 4, 2010
(86) PCT No.: PCT/CN2010/000001

§ 371 Date: Aug. 14, 2012

(51) Int. Cl. G06Q 30/00

(52) U.S. Cl. 705/400

(57) ABSTRACT

In various example embodiments, systems and methods to adaptively price items are provided. In example embodiments, an item to be priced is identified. Once identified, historical data and inventory data assocoated with the identified item are accessed. Using the historical data and inventory data, at least one recommended price for the item based on the historical data and inventory data is determined. The recommended price may be provided to a user for approval. Alternatively or in addition, the recommended price may be used as a price in a newly created item listing or the recommended price may be used as a new price in revising a price in an existing item listing.

### FIELD

The present disclosure relates generally to network-based marketplaces, and in a specific example embodiment, to provide adaptive pricing for items in the network-based marketplaces.

### BACKGROUND

Network-based marketplaces conventionally provide two pricing schemes to sellers. One pricing scheme is a fixed price scheme whereby the seller sets the price for an item for sale. Typically, the seller will either guess at the fixed price or performs a cursory review of what other similar items are being sold for and sets the fix price to such a value. The fixed price may be competitive when originally set. However, the fixed price may become less competitive if, for example, supply of the item increases or decreases, demand rises or falls, or similar items are sold under market value.

A second pricing scheme is auction pricing. With auction pricing, the seller sets a starting price and allows potential buyers to bid on the item, thereby increasing the price of the item until the auction expires.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of a network architecture of a system used to identify items depicted in images.

FIG. 2 is a block diagram illustrating an example embodiment of a publication system.

FIG. 3 is a block diagram illustrating an example embodiment of a pricing engine.

FIG. 4 is a flow diagram of an example method for providing adaptive pricing.

FIG. 5 is a flow diagram of an example method for determining an adaptive price.

FIG. 6 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

As used herein, the term “or” may be construed in either an inclusive or exclusive sense. Additionally, although various example embodiments discussed below focus on a network-based publication environment, the embodiments are given merely for clarity in disclosure. Thus, any type of electronic publication, electronic commerce, or electronic business system and method, including various system architectures, may employ various embodiments of the adaptive item pricing system and method described herein and is considered as being within a scope of example embodiments. Each of a variety of example embodiments is discussed in detail, below.

Example embodiments described herein provide systems and methods to provide adaptive item pricing. In various example embodiments, a request for adaptive item pricing is received and an item to be priced is identified. Once identified, historical data and inventory data associated with the identified item are accessed. The historical data may comprise, for example, past sale prices for the indentified item, condition of items sold and not sold (e.g., new or used), and number of the items sold over a certain time period (e.g., past month).

The historical data may further include search data for the item over a certain time period. The search data indicates the number of searches, frequency of searches, sales based on searches, or any other information associated with searches performed for the item being priced. Thus, the historical data provides some insight into demand for the identified item.

The inventory data comprises current inventory information associated with the identified item that indicates a number of the identified items currently available. Thus, the inventory data provides insight into the supply for the identified item.

Using the historical data and inventory data, at least one recommended price for the item is determined. The recommended price may be provided to a user for approval (e.g., user selects a price in a price range or approves a single recommended price). Alternatively or additionally, the recommended price may be used as a price in a newly created item listing or may be used as a new price in revising a previous price in an existing item listing.

Example embodiments adaptively price an item based on current market conditions (e.g., supply and demand for the item). The price for the item may also subsequently change as the supply or demand changes. This pricing scheme allows the user to maximize the selling price for the item without constantly monitoring the current inventory available, performing guess work while pricing the user's own item, or manually analyzing competitor prices. Because the user does not need to perform all of these actions on a system, data processing may, as an example, be reduced and bandwidth available for use on the system may be increased.

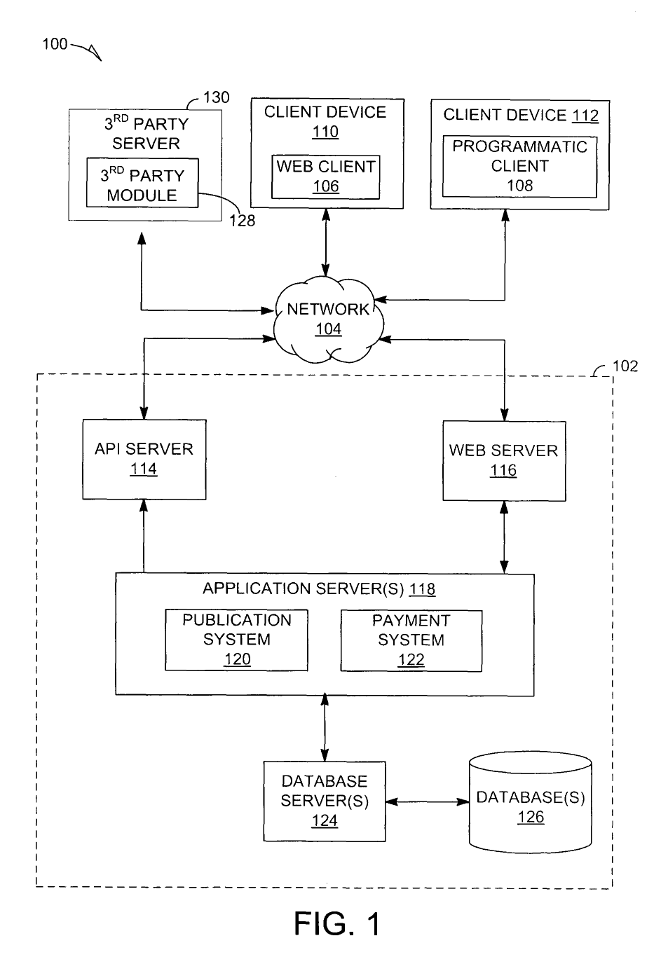

With reference to FIG. 1, an example embodiment of a high-level client-server-based network architecture 100 for providing adaptive item pricing is shown. A networked system 102, in an example form of a network-server-side functionality, is coupled via a network 104 (e.g., the Internet or Wide Area Network (WAN)) to one or more clients. FIG. 1 illustrates, for example, a web client 106 operating via a browser (e.g., such as the Internet Explorer® browser developed by Microsoft® Corporation of Redmond, Wash. State), and a programmatic client 108 executing on respective client devices 110 and 112. The client devices 110 and 112 may comprise a mobile phone, desktop computer, laptop, or any other communication device that a user may utilize to access the networked system 102.

An Application Program Interface (API) server 114 and a web server 116 are coupled to, and provide programmatic and web interfaces respectively to, one or more application servers 118. The application servers 118 host a publication system 120 and a payment system 122, which may comprise one or more modules, applications, or engines, each of which may be embodied as hardware, software, firmware, or any combination thereof. The application servers 118 are, in turn, coupled to one or more database servers 124 facilitating access to one or more information storage repositories or database(s) 126.

The storage databases 126 may store information regarding items presented on the networked system 102. For example, the items may comprise items for sale or auction via the publication system 120. The information stored may include images, current prices, start and end time for an auction, seller's information, or any other information relevant to the items.

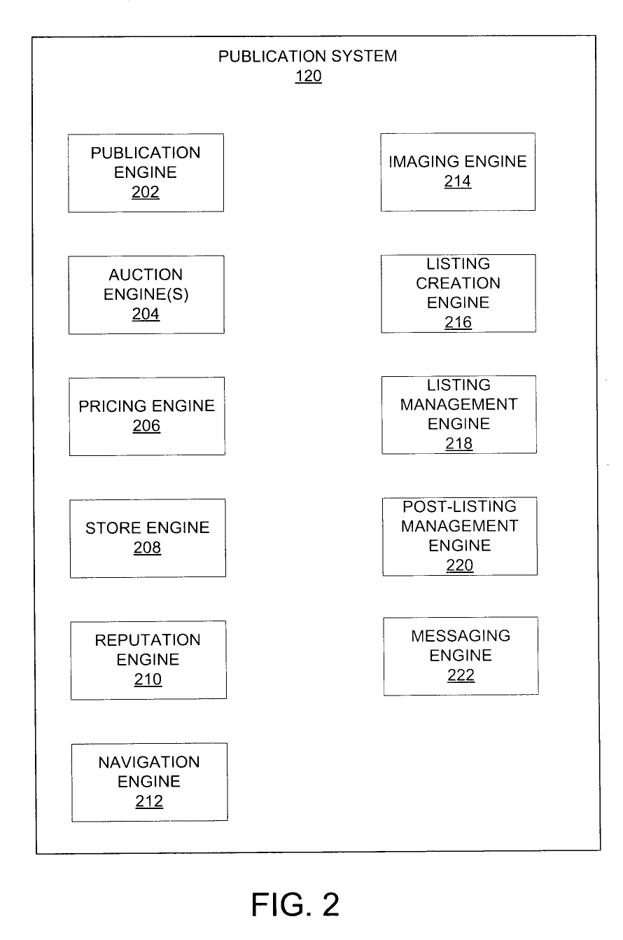

The publication system 120 provides a number of publication and marketplace functions and services to users that access the networked system 102. The publication system 120 is discussed in more detail in connection with FIG. 2.

The payment system 122 provides a number of payment services and functions to users. The payment system 122 allows users to accumulate value (e.g., in a commercial currency, such as the U.S. dollar, or a proprietary currency, such as “points”) in accounts, and then later to redeem the accumulated value for products (e.g., goods or services) that are made available via the publication system 120. The payment system 122 also facilitates payments from a payment mechanism (e.g., a bank account or credit card) for purchases of items via the network-based marketplace. While the publication system 120 and the payment system 122 are shown in FIG. 1 to both form part of the networked system 102, it will be appreciated that, in alternative embodiments, the payment system 122 may form part of a payment service that is separate and distinct from the networked system 102.

FIG. 1 also illustrates a third party module 128, executing on a third party server 130, as having programmatic access through the network 104 to the networked system 102 via the programmatic interface provided by the API server 114. For example, the third party module 128 may, utilizing information retrieved from the networked system 102, support one or more features or functions on a website (not shown) hosted by the third party. The third party website may, for example, provide one or more promotional, marketplace, or payment functions that are supported by the relevant applications of the networked system 102.

While the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system. The publication system 120 and payment system 122 may also be implemented as standalone systems or standalone software programs operating under separate hardware platforms, which do not necessarily have networking capabilities.

Referring now to FIG. 2, an example block diagram illustrating multiple components that, in one example embodiment, are provided within the publication system 120 of the networked system 102 (see FIG. 1) is shown. The publication system 120 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more database(s) 126 via the one or more database servers 124, both shown in FIG. 1.

The networked system 102 provides a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication system 120 may comprise at least one publication engine 202 and one or more auction engines 204 that support auction-format listing and price setting mechanisms (e.g., English, Dutch, Chinese, Double, Reverse auctions, etc.). The various auction engines 204 also provide a number of features in support of these auction-format listings, such as a reserve price feature whereby a seller may specify a reserve price in connection with a listing and a proxy-bidding feature whereby a bidder may invoke automated proxy bidding.

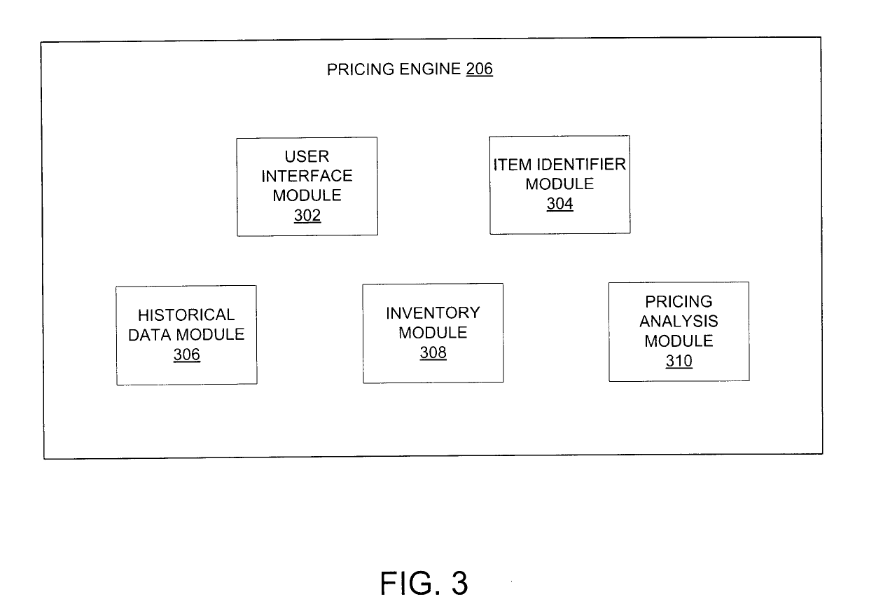

A pricing engine 206 supports various price listing formats. One such format is a fixed-price listing format (e.g., the traditional classified advertisement-type listing or a catalogue listing). Another format comprises a buyout-type listing. Buyout-type listings (e.g., the Buy-it-Now (BIN) technology developed by eBay Inc., of San Jose, Calif.) may be offered in conjunction with auction-format listings and allow a buyer to purchase goods or services, which are also being offered for sale via an auction, for a fixed-price that is typically higher than a starting price of an auction for an item. The pricing engine 206 also provides the adaptive pricing format. The pricing engine 206 will be discussed in more detail in connection with FIG. 3 below.

A store engine 208 allows a seller to group listings within a “virtual” store, which may be branded and otherwise personalized by and for the seller. Such a virtual store may also offer promotions, incentives, and features that are specific and personalized to the seller. In one example, the seller may offer a plurality of items as Buy-It-Now items in the virtual store, offer a plurality of items for auction, or a combination of both.

A reputation engine 210 allows users that transact, utilizing the networked system 102, to establish, build, and maintain reputations. These reputations may be made available and published to potential trading partners. Because the networked system 102 supports person-to-person trading between unknown entities, users may otherwise have no history or other reference information whereby the trustworthiness and credibility of potential trading partners may be assessed. The reputation engine 210 allows a user, for example through feedback provided by one or more other transaction partners, to establish a reputation within the networked system 102 over time. Other potential trading partners may then reference the reputation for purposes of assessing credibility and trustworthiness.

Navigation of the network-based publication system may be facilitated by a navigation engine 212. For example, a search module (not shown) of the navigation engine 212 enables keyword searches of listings published via the publication system 120. In a further example, a browse module (not shown) of the navigation engine 212 allows users to browse various category, catalogue, or inventory data structures according to which listings may be classified within the publication system 120. Various other navigation applications within the navigation engine 212 may be provided to supplement the searching and browsing applications.

In order to make listings available via the networked system 102 as visually informing and attractive as possible, the publication system 120 may include an imaging engine 214 that enables users to upload images for inclusion within listings and to incorporate images within viewed listings. The imaging engine 214 also receives image data from a user and utilizes the image data to identify an item depicted or described by the image data.

A listing creation engine 216 allows sellers to conveniently author listings pertaining to goods or services that sellers wish to transact via the networked system 102, while a listing management engine 218 allows sellers to manage such listings. Specifically, where a particular seller has authored or published a large number of listings, the management of such listings may present a challenge. The listing management engine 218 provides a number of features (e.g., auto-relisting, inventory level monitors, etc.) to assist the seller in managing such listings.

A post-listing management engine 220 also assists sellers with a number of activities that typically occur post-listing. For example, upon completion of an auction facilitated by the one or more auction engines 204, a seller may wish to leave feedback regarding a particular buyer. To this end, the post-listing management engine 220 provides an interface to the reputation engine 210 allowing the seller to conveniently provide feedback regarding multiple buyers to the reputation engine 210.

A messaging engine 222 is responsible for the generation and delivery of messages to users of the networked system 102. Such messages include, for example, advising users regarding the status of listings and best offers (e.g., providing an acceptance notice to a buyer who made a best offer to a seller). The messaging engine 222 may utilize any one of a number of message delivery networks and platforms to deliver messages to users. For example, the messaging engine 222 may deliver electronic mail (e-mail), an instant message (IM), a Short Message Service (SMS), text, facsimile, or voice (e.g., Voice over IP (VoIP)) messages via wired networks (e.g., the Internet), a Plain Old Telephone Service (POTS) network, or wireless networks (e.g., mobile, cellular, WiFi, WiMAX).

Although the various components of the publication system 120 have been defined in terms of a variety of individual modules and engines, a skilled artisan will recognize that many of the items can be combined or organized in other ways. Furthermore, not all components of the publication system 120 have been included in FIG. 2. In general, components, protocols, structures, and techniques not directly related to functions of example embodiments (e.g., dispute resolution engine, loyalty promotion engine, personalization engines, etc.) have not been shown or discussed in detail. The description given herein simply provides a variety of example embodiments to aid the reader in an understanding of the systems and methods used herein.

Application of Embodiments of the Adaptive Item Pricing Platform into the Example Network Architecture

Referring now to FIG. 3, an example diagram of the pricing engine 206 is shown. The pricing engine 206 provides pricing functions to the publication system 120. In example embodiments, the pricing engine 206 comprises a user interface module 302, an item identifier module 304, a historical data module 306, an inventory module 308, and a pricing analysis module 310. Alternative embodiments may comprise more, less, or functionally equivalent components.

The user interface module 302 provides communications between a user (e.g., a seller or merchant) and the other components of the pricing engine 206. A request or trigger for adaptive item pricing is initially received by the user interface module 302. In some embodiments, upon calculation of a recommended price, the user interface module 302 may provide the result to the user for approval. Further, the user interface module 302 may receive other instructions from the user. For example, the user may provide a desired price range within which the user wants the recommended price to fall.

The user may also indicate, via the user interface module 302, whether a listing created by the publication system 120 using adaptive item pricing should be dynamically adapted. In some examples, the user may also provide a price range between which the price may be automatically adapted to based on market conditions. Thus, an active listing posted on the publication system 120 (e.g., a network-based marketplace) may change its price based on, for example, current supply and demand within a particular price range if supplied by the user.

The item identifier module 304 determines the item to be priced. In some embodiments, the request received via the user interface module 302 from the user may contain an item identifier. Examples of item identifiers include a UPC, a bar code, a BIN number. Alternatively, the item may be identified using a unique description or unique name of the item (e.g., SONY PLAYSTATION III, APPLE IPOD SHUFFLE). In yet other embodiments, an image of the item may be received that is analyzed by the imaging engine 214 to identify the item.

Once identified, the historical data module 306 accesses historical data associated with the identified item. The historical data may include, for example, past sale prices for the item and number of the items sold over a certain time period (e.g., past month). The historical data may further include search data for the item over a certain time period. The search data indicates the number of searches, frequency of searches, sales based on searches, or any other information associated with searches performed for the item being priced.

In various embodiments, the historical data may be stored in one or more tables. These tables may be stored in databases or storage devices communicatively coupled to the publication system 120 (e.g., database 126). For example, an item table may maintain item records for goods and services that are available to be, or have been, transacted via the publication system 120: Transaction tables may contain records for each purchase or sales transaction pertaining to items in the item tables. Furthermore, search tables may maintain records of searches performed for various items. Additional tables may be used as needed by the system.

The inventory module 308 accesses current inventory information associated with the identified item. For example, the inventory module 308 may access one or more databases containing listings of items currently being offered for sale. By reviewing this accessed information, the inventory module 308 may determine a number of the identified items currently available on the publication system 120 or associated network-based marketplace.

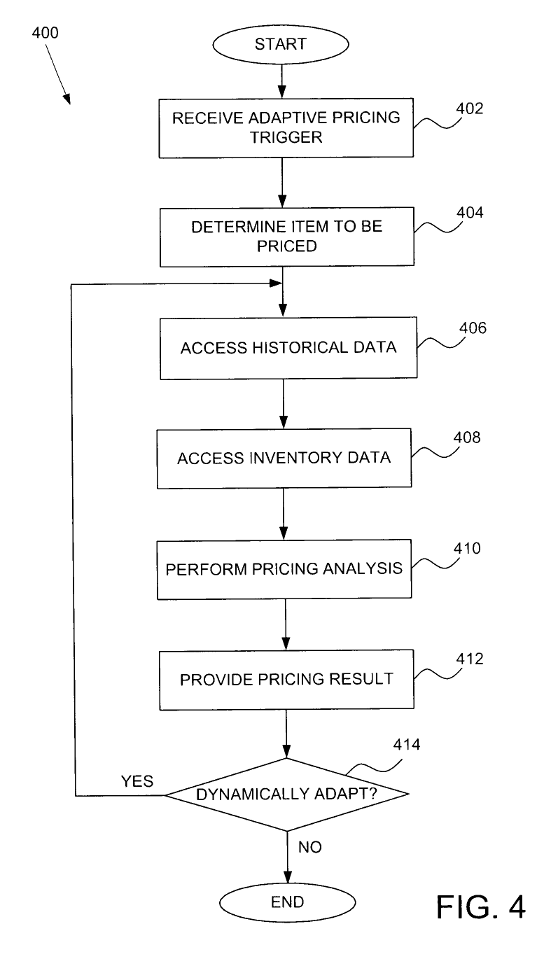

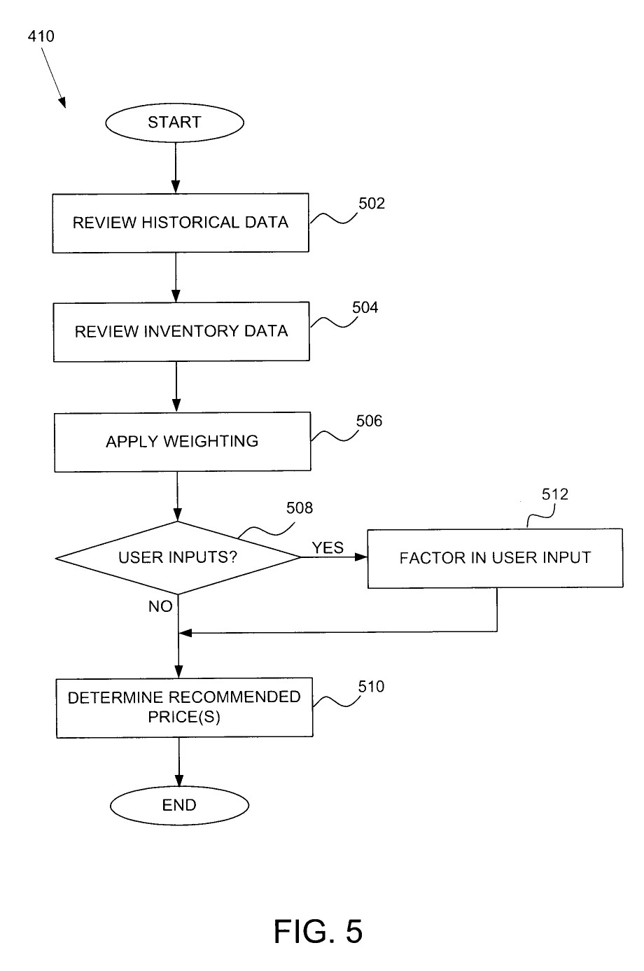

The pricing analysis module 310 determines a recommended price or price range for the identified item. In example embodiments, the pricing analysis module 310 will receive the historical data and inventory data and weigh the data in order to determine the recommended price or price range. The analysis may take into account user inputs such as, for example, a desired minimum price, desired maximum price, or desired price range. The pricing analysis process will be discussed in more detail in connection with FIG. 4 and FIG. 5.

Referring now to FIG. 4, a flow diagram of an example method 400 to provide adaptive item pricing is illustrated. In operation 402, an adaptive pricing trigger is received. In one embodiment, a user (e.g., seller or merchant) may indicate, for example, a desire to use adaptive item pricing in generating their item listing while generating an item listing.

The item to be priced is determined in operation 404. In some embodiments, the adaptive pricing trigger received in operation 402 may comprise an item identifier. The item identifier may be, for example, a UPC, bar code, BIN number, image, item description, or item name. In the embodiments where the item identifier is the UPC, bar code, or BIN number, the item identifier module 304 may translate the code or number into an item name. Alternatively, the item identifier module 304 may take an item identifier and translate the item identifier to a publication system specific identifier (e.g., in order to access a database organized with publication system specific identifiers). Any type and style of item identifiers may be used so long as the item identifier allows the item identifier module 304 to determine the item to be priced.

Once the item is identified, historical data associated with the identified item may be accessed in operation 406. The historical data may comprise for example, past sale prices for the item and number of the items sold over a certain time period (e.g., past month). The historical data may further include search data for the item over a certain time period that indicates a number of searches performed for the identified item, frequency of those searches, sales based on the searches of the identified item, or any other information associated with searches performed for the item being priced.

At operation 408, inventory data associated with the identified item is accessed. In one embodiment, the inventory module 308 accesses one or more databases containing listings of items currently being offered for sale. By reviewing this accessed information, the inventory module 308 may determine a number of the identified items currently available on the publication system 120 or associated network-based marketplace.

The pricing analysis is performed in operation 410. The pricing analysis may take into consideration the historical data and current inventory associated with the identified item as well as any user inputs to determine one or more recommended prices. The pricing analysis process is discussed in more detail in connection with FIG. 5 below.

A pricing result from the pricing analysis is provided in operation 412. In one embodiment, the pricing result may be provided back to the user for approval. In this embodiment, the user interface module 302 forwards the pricing result and requests the approval of the pricing result. If approved, the pricing result may be used to generate or update an item listing for the identified item. In another embodiment, the pricing result may be provided to the listing creation engine 216 for insertion into an item listing for the identified item without user approval of the pricing result.

In operation 414, a determination is made as to whether the price for the identified item in an item listing should be dynamically adapted. In some embodiments, the user may allow the pricing engine 206 to periodically revise or adapt the price listed in the item listing to reflect current supply (e.g., inventory) and demand (e.g., more searches for the item sudden occurring or the item otherwise increasing in popularity). If the dynamic adaptation is requested (e.g., indicated by the user in the adaptive pricing trigger), then the method returns to operation 406 (e.g., at some period of time after a last pricing result is provided) to access the updated historical data and inventory data.

Referring now to FIG. 5, a flow diagram of an example method for performing pricing analysis (e.g., operation 410) is illustrated. In example embodiments, the operations of the method of FIG. 5 are performed by the pricing analysis module 310. In operation 502, historical data is reviewed. The historical data is received from the historical data module 306 which retrieves the historical data based on the item identifier for the item being priced. Similarly, in operation 504, inventory data is reviewed. The inventory data is received from the inventory module 308, which retrieved the inventory data based on the item identifier.

Weighting may be applied in operation 506 to the reviewed data. For example, current inventory may be considered more important than past sale prices, especially for a short-lived fad or event specific items (e.g., tickets to events, souvenirs from an event). In this example, the current inventory will be weighted more highly then the historical data.

At operation 508, a determination is made as to whether the user provided any pricing inputs. For example, the user may have suggested a desired minimum price, a desired maximum price, or a desired price range. If no user input is provided, then at operation 510, at least one recommended price is determined. The recommended price may be a single price that may be used as the price in generating or updating an item listing for the identified item. Alternatively, the recommended price may be a price range from which the user may select a particular price to use in generating or updating a price in the item listing.

If user inputs are provided in operation 508, then the user inputs are factored in at operation 512. For example, if the user provided a desired minimum price, then the pricing analysis module 310 will determine recommended price(s) that is above the user provided minimum price in operation 510.

For example, an adaptive price may be defined as its originally listed price times an adaptive pricing factor alpha, α, which updates automatically in the system at a predefined interval defined as t (e.g., every eight hours). The adaptive price is a function of both the predefined interval and a number of updates (n̂t). Therefore, the adaptive price may be represented as, for example,

adaptive price (n̂t)=α(n̂t)*original price (1)

An example for defining the adaptive pricing factor, α, that changes with the predefined interval and the number of updates(n̂t) is

α=f(θ,τ,δ) (2)

That is, alpha, α, may be a function of the following parameters: seasonal demand, θ, (e.g., academic semester timing for books), shopping impulse, τ, (e.g., CDs and DVDs of Michael Jackson following his passing), and ambient fluctuation, δ, (e.g., recent local deals). The parameters (θ, τ, and δ) change with n̂t accordingly, and are based on the historical data reviewed in operation 502. For example,

$$α = \frac{( 1 + θ )}{( 1 + \text{?} )} \times \text{?} \\ \text{?} \text{indicates text missing or illegible when filed} \qquad ( 3 )$$

For example, a seasonal demand factor, θ, (e.g., Christmas seasonal demand factor) may be obtained empirically according to history and economics. Ambient fluctuation, δ, (e.g., local fluctuation) can be obtained statistically with on-line activity detection. Item specific factors may further take impulse (e.g., shopping spree impulse, t) into account. In some cases, an identification function may be used to recognize a specific need for certain items. That is, changes are monitored such that the system identifies, for example, impulses or fluctuations, and tracks whether a threshold is reached. Once a strong need is recognized by the system, this item specific identification factor may come into play. In example embodiments, current inventory data may be factored into these equations when sold, such that each sold item updates the historical data.

Since a user can set their maximal and minimal prices, the final adaptive price will take that range into account. Additionally, the final adaptive price may be rounded into a reasonable dollar amount for easy handling by the system. For example, a book is initially listed at $40 with a maximum price of $80 and minimal price of $20. If α=120%, then the adaptive price may be $48.

### Modules, Components, and Logic

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term module should be understood to encompass a tangible entity, be that an entity that is physically constructed, permanently configured (e.g., hardwired), or temporarily configured (e.g., programmed) to operate in a certain manner or to perform certain operations described herein.

Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Machine Architecture and Machine-Readable Medium

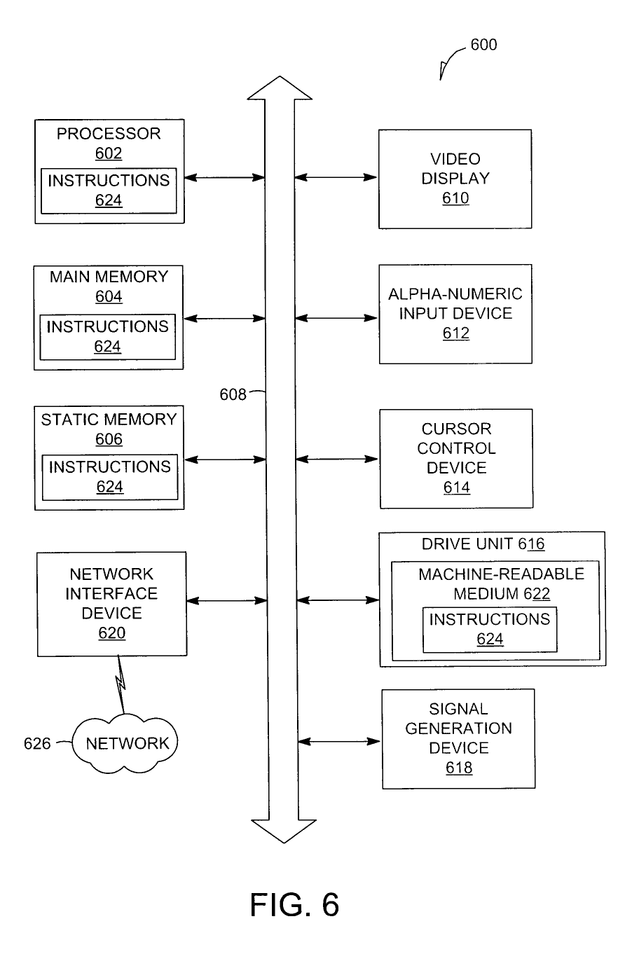

With reference to FIG. 6, an example embodiment extends to a machine in the example form of a computer system 600 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 may include a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). in example embodiments, the computer system 600 also includes one or more of an alpha-numeric input device 612 (e.g., a keyboard), a user interface (UI) navigation device or cursor control device 614 (e.g., a mouse), a disk drive unit 616, a signal generation device 618 (e.g., a speaker), and a network interface device 620.

### Machine-Readable Medium

The disk drive unit 616 includes a machine-readable medium 622 on which is stored one or more sets of instructions 624 and data structures (e.g., software instructions) embodying or used by any one or more of the methodologies or functions described herein. The instructions 624 may also reside, completely or at least partially, within the main memory 604 or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Transmission Medium

The instructions 624 may further be transmitted or received over a communications network 626 using a transmission medium via the network interface device 620 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
identifying an item to be priced;
accessing historical data associated with the identified item;
accessing inventory data associated with the identified item;
determining, using one or more processors, at least one recommended price for the item based on the historical data and inventory data; and
using the at least one recommended price in an item listing for the item.

2. The method of claim 1, wherein the at least one recommended price comprises a price range from which a user may select a price.

3. The method of claim 1, further comprising generating the item listing for the identified item.

4. The method of claim 1, wherein the using of the at least one recommended price comprises automatically revising a price in the item listing using the at least one recommended price.

5. The method of claim 4, further comprising determining that the at least one recommended price is within a user provided price range prior to automatically revising the price in the item listing.

6. The method of claim 1, further comprising receiving user input for use in the determining of the at least one recommended price.

7. The method of claim 6, wherein the user input comprises at least a desired minimum price or a desired maximum price.

8. The method of claim 1, wherein the historical data comprises data associated with past sales of items similar to the identified item.

9. The method of claim 1, wherein the historical data comprises data associated with searches performed for items similar to the identified item.

10. A system comprising:
an item identifier module to identify an item to be priced;
a historical data module to access historical data associated with the identified item;
an inventory module to access inventory data associated with the identified item; and
a pricing analysis module to determine, using one or more processors, at least one recommended price for the item based on the historical data and inventory data.

11. The system of claim 10, further comprising a user interface module to provide the at least one recommended price to a user for selection of a price.

12. The system of claim 10, further comprising a user interface module to receive user input used to determine the at least one recommended price.

13. The system of claim 10, further comprising a listing creation engine to use the at least one recommended price in generating an item listing.

14. The system of claim 10, further comprising a listing creation engine to use the at least one recommended price in revising a price in an existing item listing.

15. A machine-readable storage medium in communication with at least one processor, the machine-readable storage medium storing instructions which, when executed by the at least one processor, performs a method comprising:
identifying an item to be priced;
accessing historical data associated with the identified item;
accessing inventory data associated with the identified item;
determining, using one or more processors, at least one recommended price for the item based on the historical data and inventory data; and
using the at least one recommended price in an item listing for the item.

16. The machine-readable storage medium of claim 15, wherein the method further comprises generating the item listing.

17. The machine-readable storage medium of claim 15, wherein the method further comprises providing the at least one recommended price to a user for selection of a price.

18. The machine-readable storage medium of claim 15, wherein the using of the at least one recommended price comprises automatically revising a price in the item listing using the at least one recommended price.

19. The machine-readable storage medium of claim 18, wherein the method further comprises revising a price in the item listing if the at least one recommended price is within a user provided price range.

20. The machine-readable storage medium of claim 15, wherein the method further comprises receiving user input for use in the determining of the at least one recommended price, the user input comprising a desired minimum price or a desired maximum price.
